(19) United States
(12) Patent Application Publication
(10) Pub. No.: US 2025/0385832 A1
(43) Pub. Date: Dec. 18, 2025

(54) METHOD AND SYSTEM TO MITIGATE FAULT IN A DISTRIBUTED SYSTEM

(71) Applicant: Telefonaktiebolaget LM Ericsson (publ), Stockholm (SE)

(72) Inventors: Harald GUSTAFSSON, Lund (SE); Raquel MINI, Dalby (SE)

(73) Assignee: Telefonaktiebolaget LM Ericsson (publ), Stockholm (SE)

(21) Appl. No.: 18/877,216

(22) PCT Filed: Jun. 23, 2022
(86) PCT No.: PCT/IB2022/055843

§ 371 Date: Dec. 19, 2024

(51) Int. Cl. H04L 41/0654; H04L 41/40

(52) U.S. Cl. CPC H04L 41/0654; H04L 41/40

(57) ABSTRACT

Embodiments include methods, electronic device, storage medium, and computer program for fault mitigation in a distributed system. In one embodiment, a method comprises obtaining measurements related to one or more one-way data flows that are from one or more source service instances and that are to be distributed to one of at least two destination service instances in the distributed system; determining the obtained measurements indicating that distribution of a one-way data flow within the one or more one-way data flows to a destination service instance of the at least two destination service instances fails to comply with a quality-of-service requirement; and causing reroute of the one-way data flow to be distributed to another destination service instance instead of the destination service instance.

### TECHNICAL FIELD

Embodiments of the invention relate to the field of networking; and more specifically, to mitigating fault in a distributed system.

### BACKGROUND ART

A fundamental principle of a cloud native application is to decompose software into smaller and more manageable loosely coupled pieces. This concept is not new. It has always been good practice to divide code into more manageable pieces; what is new, however, is that each piece has a well-bounded scope and can now be individually deployed, scaled, and upgraded. In addition, those pieces communicate through well-defined and version-controlled network-based interfaces. These communicating pieces form a distributed system.

Cloud native is about how applications are created and deployed and it uses the concept of building and running applications to take advantage of one or more distributed systems offered by the cloud delivery model. Those applications are designed and built to exploit the scale, elasticity, resiliency, and flexibility the cloud provides. For example, the fifth generation (5G) use cases drive the need for cloud native applications such as the third Generation Partnership Project (3GPP) standardized 5G Core network functions. This increases speed in application development and efficiency of the distributed systems.

For an application in a distributed system to be reliable even during faults on individual parts, the faulty parts need to be quickly identified and isolated and other parts of the distributed system take over the tasks. Remote Procedure Calls (RPCs) are traditionally used in a distributed system, and a request and its response are available at the same node of an RPC driven system, allowing mitigating faults from local response information. Yet in other distributed systems, operations tend to be distributed to different nodes, the response of a call may not return to the caller node, and that makes implementing fault mitigation from local information unsuitable in the other distributed systems.

### SUMMARY OF THE INVENTION

Embodiments include methods, electronic device, storage medium, and computer program for fault mitigation in a distributed system. In one embodiment, a method comprises obtaining measurements related to one or more one-way data flows that are from one or more source service instances and that are to be distributed to one of at least two destination service instances in the distributed system; determining the obtained measurements indicating that distribution of a one-way data flow within the one or more one-way data flows to a destination service instance of the at least two destination service instances fails to comply with a quality-of-service requirement; and causing reroute of the one-way data flow to be distributed to another destination service instance instead of the destination service instance.

Embodiments include electronic devices for fault mitigation in a distributed system. In one embodiment, an electronic device comprises a processor and machine-readable storage medium that provides instructions that, when executed by the processor, are capable of causing the electronic device to perform: obtaining measurements related to one or more one-way data flows that are from one or more source service instances and that are to be distributed to one of at least two destination service instances in the distributed system; determining the obtained measurements indicating that distribution of a one-way data flow within the one or more one-way data flows to a destination service instance of the at least two destination service instances fails to comply with a quality-of-service requirement; and causing reroute of the one-way data flow to be distributed to another destination service instance instead of the destination service instance.

Embodiments include machine-readable storage media for fault mitigation in a distributed system. In one embodiment, a machine-readable storage medium that provides instructions that, when executed, are capable of causing the electronic device to perform: obtaining measurements related to one or more one-way data flows that are from one or more source service instances and that are to be distributed to one of at least two destination service instances in the distributed system; determining the obtained measurements indicating that distribution of a one-way data flow within the one or more one-way data flows to a destination service instance of the at least two destination service instances fails to comply with a quality-of-service requirement; and causing reroute of the one-way data flow to be distributed to another destination service instance instead of the destination service instance.

By implementing embodiments as described, faulty entities within a distributed system may be quickly identified and acted upon based on the violation of QoS requirements, where collected observation information may be used to derive such violation. Such fault mitigation works well when data flows are distributed in a communication system that has multiple service instances for one or more services.

### BRIEF DESCRIPTION OF THE DRAWINGS

The invention may best be understood by referring to the following description and accompanying drawings that are used to illustrate embodiments of the invention. In the drawings:

FIG. 1 illustrates an architecture for fault mitigation in a distributed system per some embodiments.

FIG. 2A illustrates traces and spans in a distributed system per some embodiments.

FIG. 2B illustrates updated traces and spans upon fault mitigation in a distributed system per some embodiments.

FIG. 3 illustrates a list of parameters that may be included in a collected observation from a service instance per some embodiments.

FIG. 4 illustrates a list of parameters that indicate performance of a source or destination service instance based on collected observations per some embodiments.

FIG. 5 illustrates an implementation of fault mitigation in a distributed system per some embodiments.

FIG. 6 is a flow diagram illustrating operations for fault mitigation per some embodiments.

FIG. 7A illustrates connectivity between network devices (NDs) within an exemplary network, as well as three exemplary implementations of the NDs per some embodiments.

FIG. 7B illustrates an exemplary way to implement a special-purpose network device per some embodiments.

FIG. 7C illustrates various exemplary ways in which virtual network elements (VNEs) may be coupled per some embodiments.

FIG. 7D illustrates a network with a single network element (NE) on each of the NDs, and within this straight forward approach contrasts a traditional distributed approach (commonly used by traditional routers) with a centralized approach for maintaining reachability and forwarding information (also called network control) per some embodiments.

FIG. 7E illustrates the simple case of where each of the NDs implements a single NE, but a centralized control plane has abstracted multiple of the NEs in different NDs into (to represent) a single NE in one of the virtual network(s) per some embodiments.

FIG. 7F illustrates a case where multiple VNEs are implemented on different NDs and are coupled to each other, and where a centralized control plane has abstracted these multiple VNEs such that they appear as a single VNE within one of the virtual networks per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Fault Mitigation Architecture

In a service mesh system, a fault may be discovered when a Remote Procedure Call (RPC) response timeout or a standard status in a response indicates a fault in a service. To mitigate such fault, a remote procedure call (RPC) driven approach may be implemented, where a request to mitigate and the response to the request are available at the same network node. Yet such RPC based implementation may be impracticable for a distributed system that is event/message driven, where the observability of success/timeliness of an operation needs to be distributed instead of potentially local, since the response indicating a fault in a service may be returned to the caller at another network node. Thus, for an event/message-driven system, the fault mitigation problem becomes distributed. Also, the messages in such a system do not have a standard status indication and the timeout/missing message may be delivered one or two magnitudes slower than data transmission in a real time application using the distributed system, thus the event/message driven fault mitigation needs to operate fast.

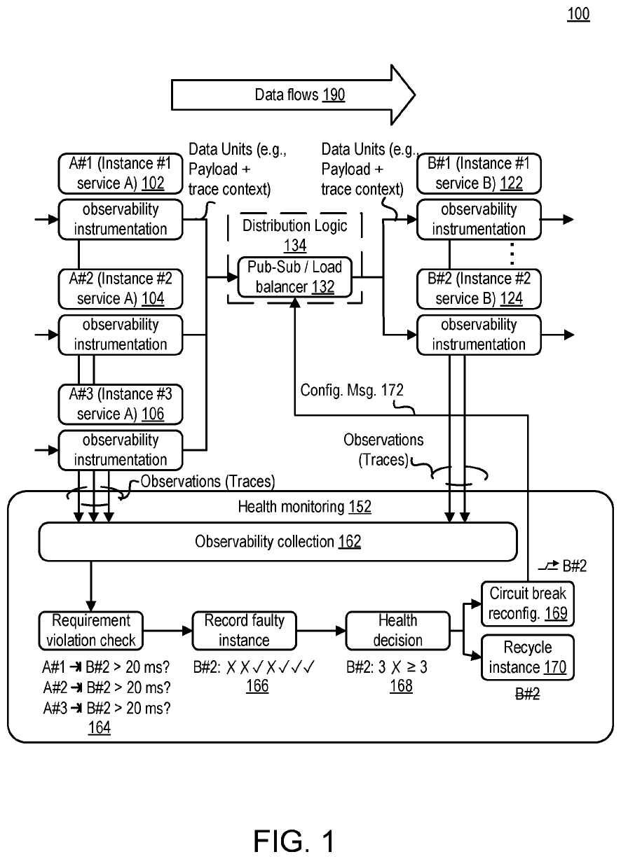

Embodiments of the invention may identify and isolate the faulty parts quickly in a distributed system, and other parts of the distributed system may take over the tasks performed by the identified faulty parts. FIG. 1 illustrates an architecture for fault mitigation in a distributed system per some embodiments. While the architecture may be used for a broad range of applications, examples below discuss its usage in a real-time application in some embodiments and the system may be referred to as a real-time system.

A system 100 as shown includes a set of service instances 102 to 106 and 122 to 124, a publication/subscription broker or load balancer module 132, and a health monitoring module 152. Each service instance is implemented with observability instrumentation, which collects observations (e.g., information on messages and statuses) of service instances in the distributed system. The collected observations may be used to derive measurements about processing data units of data flows by service instances, including timing information since that is highly relevant in a real-time system. The system directs traffic toward service instances for redundancy needs as well as performance, as multiple alternative service instances may keep utilization of compute, memory, network, and other resources at a level able to take over tasks from faulty service instances. Note that a service instance may also be referred to as an application instance or software instance in some embodiments.

Each service instance may be a virtual machine (VM) that executes an application/service in a virtualization or emulation computing system in some embodiments. Alternatively, each service instance may be a pod in Kubernetes cluster, which is a part of an open-source container orchestration system for automating software deployment, scaling, and management, where a pod includes one or more containers that are to be co-located on the same node. Furthermore, in other embodiments each service instance may be a device in a cyber-physical system (CPS) or intelligent system, which includes a computing system in which a mechanism is controlled or monitored by computer-based algorithms.

Data flows are distributed from service A instances 102 to 106 to service B instances 122 to 124, and the former may be referred to as source service instances and the latter destination service instances. The distribution is coordinated by publication/subscription broker or load balancer module 132. In a publication/subscription model (also referred to as a producer/consumer model, a producer/subscriber model, and etc.), the publication/subscription broker manages publication by the source service instances and subscription of the publication by the destination service instances. In a load-balancing model, a load balancer distributes data flows from the source service instances to the destination service instances to maintain proper load distribution among the destination service instances based on their respective capabilities. Note that in the publication/subscription model, the publication/subscription broker may perform load balancing operations as well.

While publication/subscription broker or load balancer module 132 may be a standalone distribution logic 134 (e.g., being implemented in hardware or software of an electronic device) in some embodiments, in other embodiments, publication/subscription broker or load balancer module 132 is virtualized on shared resources (e.g., a container in a pod, a distribution service in a cloud, a module in/related to the source/destination service instance) of system 100.

The data units of data flows are transmitted one-way (unidirectional) from the source service instances to the destination service instances as shown at reference 190. Each data flow may be identified by a set of attributes embedded to one or more data units of the data flow. An exemplary set of attributes includes a 5-tuple (source and destination IP addresses, a protocol type, source and destination TCP/UDP ports); and another set of attributes includes data flow identification information used in fault mitigation partition keys, trace/span IDs, as discussed in more details herein below. A data flow may also be referred to as a traffic flow or a stream, and it carries application payloads (e.g., payloads of an end-user application) from a source service instance to a destination service instance.

A data unit of a data flow may include a packet, a frame, or another protocol data unit (PDU) to carry a payload of the corresponding data flow (data plane traffic of the data flow, the payloads of an end-user application); and additionally/alternatively, the data unit may include a control message such as metadata of the data flow and/or extra information for fault mitigation, both of which may be included into a header or payload of the data unit (control plane traffic of the data flow) to manage the data flow in the distributed system. That is, a data unit may include an application payload (e.g., a payload of an end-user application), and/or a control message itself; and when the data unit includes a control message without an application payload, it corresponds/maps to a data unit with a payload. In the figure, payload (representing application payload) and trace context (a type of control message) are shown as being transmitted while the data flows are distributed to destination service instances in the distributed system. While only one-way traffic flow is shown in the figure, a two-way traffic flow is the sum of two one-way traffic flows with source and destination service instances being reversed, thus the fault mitigation mechanisms in embodiments of the invention may be implemented for two-way traffic flows as well.

Health monitoring module 152 analyzes observed observations to discover faults, avoids faulty instances quickly, and recycles the faulty instances. The observations, in the form of traces as explained in further detail herein below, provide information to check for quality-of-service (QoS) requirement violations. In this example, the observations from source and destination service instances are obtained by observability collection 162, which provides information for requirement violation check at reference 164. In this example, the requirement violation check on destination instance #2 of service B (B #2) is data unit latency (also referred to as delay) comparing to a threshold of 20 milliseconds (ms). The comparison result is provided to record fault instances at reference 166, which shows that the latency measurements show that the latency is below 20 milliseconds four times and above 20 milliseconds three times in a monitored period. The record is provided to health decision at reference 168, where the decision is that B #2 is unhealthy because the configured threshold for the monitored period is that QoS requirement violation must be below three to be deemed healthy.

Once a destination instance is determined to be unhealthy, a circuit break reconfiguration module 169 will issue a configuration message 172 to cause publication/subscription broker or load balancer module 132 to reroute to avoid the faulty destination instance B #2. The recycle/reconfiguration is referred to as circuit breaking. Additionally/alternatively, the destination instance may be recycled (also referred to as removed/deleted/dropped) at reference 170, and B #2 is thus recycled.

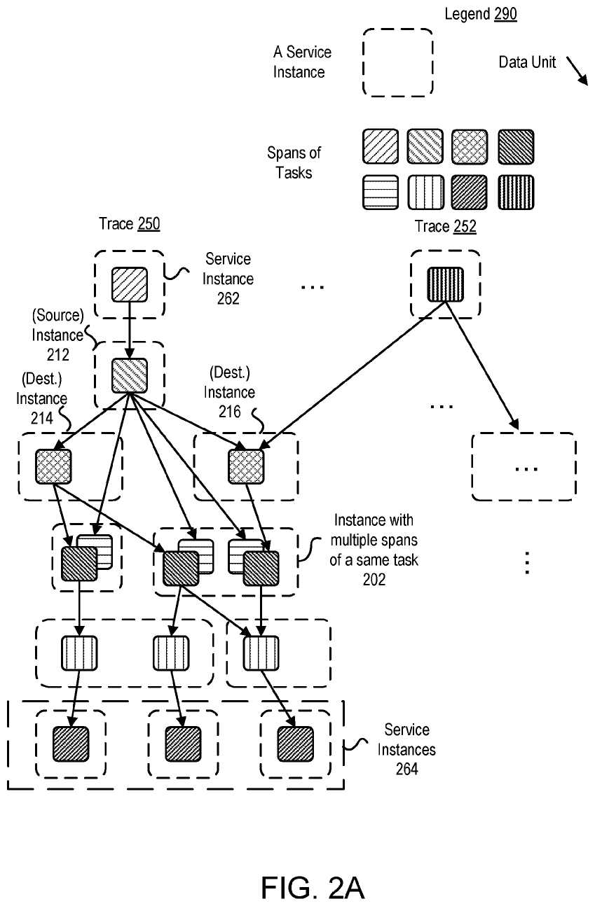

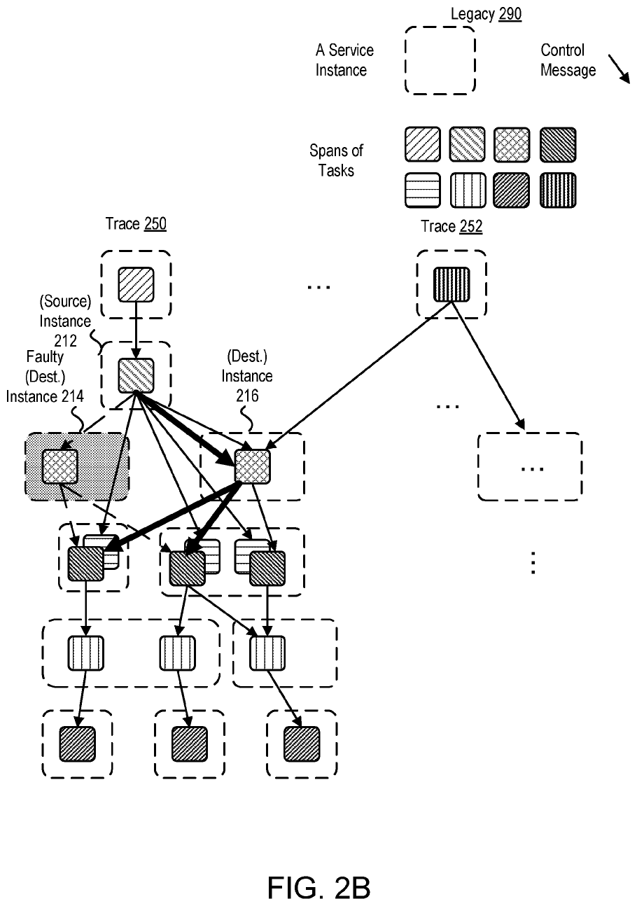

Circuit breaking is a technique to stop using an endpoint of a data flow in a distributed system, so that the data flow goes to another endpoint. Circuit breaking is required to cause publication/subscription broker or load balancer module 132 to reconfigure so that an upcoming data unit can be directed toward another service instance immediately. A publication/subscription broker may support circuit breaking by issuing an “unwatch of a subscriber” command (explicitly or implicitly specifying an unhealthy subscriber client), which removes the unhealthy subscriber client (B #2 in this example). The publication/subscription broker then redistributes partition keys (explained in further detail relating to FIG. 2 herein below) to other existing subscribers in the group (B #1 in this example) so the recycle of the unhealthy service instance no longer affects the monitored data flow.

Afterward, the system may instantiate another destination service instance providing functionalities similar to the identified unhealthy service instance, and once the new destination service instance is ready, the publication/subscription broker may add the newly instantiated destination service instance as a client to potentially cause another reroute of the data flow to the new destination service instance. Similarly, a load balancer may also remove an identified unhealthy destination service instance in its load balancing operations and add a new destination service instance providing functionalities similar to the identified unhealthy service instance once it's ready. Different systems use different mechanisms to initiate a service instance. For example, in a Kubernetes cluster based system, an orchestration module may keep the replica count the same by creating a new service instance.

While latency is used as an example of a QoS requirement to be checked, other QoS requirements can be checked using the architecture as well. For example, the measurements provided by the traces may include one or more of data unit jitter (the latency variance of data units within the same data flow), data loss/degrade, out-of-order delivery, throughput, corrupted data, incomplete data, undecodable/unreadable data, and data processing exception. Any of the measurements may cause circuit breaking to mitigate an identified fault that causes violation of one or more QoS requirements, demanded by a service level agreement (SLA), specified by a service operator, or otherwise deemed necessary for a monitored data flow. Check the compliance of a QoS requirement may include comparing measurements to a threshold, and a measurement (or a number of measurements over a time period) crossing the threshold causes the determination of QoS requirement violation. Additionally, machine learning techniques, such as support vector machine, decision tree, Bayesian network, and neural networks, can be used in the determination of QoS requirement violation.

### Traces and Spans

As shown in FIG. 1, the traces from source and destination service instances are obtained by health monitoring module 152. The concept of traces and spans are used in Open Telemetry, an observation specification and open source library. A trace may have a number of spans, and a trace may be viewed as a directed acyclic graph (DAG) of spans (also referred to as a span graph), where the edges between spans are defined as a parent/child relationship. A directed acyclic graph (DAG) is a directed graph with no directed cycles. The directed acyclic graph of spans comprises vertices of spans and edges (edges are also called arcs and they represent data units, which may include control messages), with each edge directed from one vertex to another.

In an RPC based implementation, a parent span has duration covering all children spans, since the parent only ends when a response is returned. For a distributed system that is an event/message-driven, the parent span typically ends soon after initiating sending the last data unit. FIG. 2A illustrates traces and spans in a distributed system per some embodiments. The distributed system includes multiple traces, represented by traces 250 and 252, each starting with a root. While trace 250 is shown in detail with spans/data units, other traces such as trace 252 include similar/different spans/data units. The legend of service instance, data unit, and spans of tasks is shown at reference 290.

Each service instance may have many different operations that the service instance performs on incoming data, so a service instance may be modularized into one or more tasks. A trace is an observation of one data flow through the tasks within the service instances through which the data flows are processed in the distributed system. Trace 250, for example, includes observations of a data flow through the tasks in service instance 262 (root) and through the directed acyclic graph (DAG) of spans to the service instances 264 (leaves). A span is an observation of a task execution, and a span duration comprises a time period to process data units and potentially send and/or receive data units.

The figure shows span observations of tasks processing and sending/receiving data units. A same task may be performed across multiple service instances and these tasks may be referred to as a task group. The tasks within the same task group are shown as boxes with an identical pattern fill. A service instance may have multiple types of tasks, each shown in a pattern fill. A service instance may include the same task multiple times, due to that the same task in one service instance produced two span observations since the task was triggered twice by separate data units. Service instance 202 shows an example of a service instance with multiple spans of a same task (two types of tasks each with two tasks are shown).

Each edge shows a data flow distribution. The data flow distribution may use a publish and subscribe or load-balancing mechanism and the corresponding data units are processed in different service instances. Configuration messages (e.g., configuration message 172) may cause a distribution logic (e.g., distribution logic 134) to perform routing/partitioning (or rerouting) of the data flows in some embodiments.

In these embodiments, extra information for fault mitigation included in data units (e.g., packets, frames, or other PDUs) of a data flow may be used to consistently select one route endpoint from multiple alternative endpoints. The extra information may be provided to the corresponding load balancer or publication/subscription broker by the source service instance. The usage of the extra information may be configured in a configuration message, so that based on the extra information, the corresponding load balancer or publication/subscription broker uses a consistent hash to route the data flows. The extra information in a control message may contain a hash value (included in the header or payload of a PDU) generated by a hash function for a data flow, and the hash value may be referred to as a partition key of the data flow. Independently of which source service instance is the publisher (also referred to as the producer) of data units, as long as they use the same partition key, the data units end up at the same destination service instance. Since a partition key maps to a route to a particular destination service instance, and the partition key mapping may be reconfigured (e.g., by the distribution logic) upon an event (e.g., receiving a configuration message from a health monitoring module for circuit breaking or adding/removing a subscriber), such routing may be referred to as semi-static (static until reconfiguration, and also referred to as semi-fixed). Such partition key based routing is advantageous over prior approaches for providing scaled services in a distributed system as it enables linearization, reduces contention, allows having related data units in local cache.

The parent/child relationship indicated by an edge may also indicate a source and destination service instance relationship. For example, source service instance 212 in FIG. 2A may be similar to one of source service instances 102 to 106 while destination service instances 214 and 216 in FIG. 2A may be similar to destination service instances 122 and 124.

FIG. 2B illustrates updated traces and spans upon fault mitigation in a distributed system per some embodiments. Observations at the spans of traces are collected and used to identify a faulty entity. In this example, the faulty entity corresponds to destination service instance 214 as shown in the directed acyclic graph of spans. The identification of the faulty entity causes circuit breaking to reroute one or more data flows away from destination service instance 214, and the configuration message may cause the distribution logic (e.g., distribution logic 134) to perform routing/partitioning of the data flows to destination service instance 216 under the faulty condition. In some embodiments, the routing/partitioning is based on a hash value, which was mapped to destination service instance 214, now mapped to destination service instance 216. The hash value, which may be generated by a hash function, is the updated partition key that causes the one or more data flows to consistently reroute to the other destination service instance (destination service instance 216 in this example).

While partition keys may be used for reroute of data flows, other mechanisms may also be used. For example, mapping/routing tables (e.g., flow tables in software defined networking (SDN) system) may be used, and the mapping for a data flow may be switched from destination service instance 214 to destination service instance 216 through updating a corresponding flow table entry upon the faulty entity being identified.

Note that a faulty entity causes not only reroute at one layer in a directed acyclic graph, but also reroute at the next layer too in the example of FIG. 2B. That is, reroute of a data flow to service instance 216 as the destination service instance causes a change of source service instance for the next layer as well. The route at the next layer may be determined based on measurements of transmitting data units from the new source service instance to its destination service instance, and such reroute may be performed at the distribution logic as discussed herein above.

Also note that to maintain the trace context in a distributed system, the trace context may be injected/extracted into the data units sent between tasks in some embodiments. The trace context includes a trace identifier (ID) and a span ID. A trace may have local spans as well; for example, a receiving span may call internal tasks with their own spans (local spans).

One span in the directed acyclic graph (DAG) of spans gives one observation on how data spreads and which tasks are executed, typically from one initial source that creates the root trace context. At any time, it is possible (or even likely) that many of these spans are created simultaneously using different or shared instances and tasks for the data, thus multiple traces may be included in the DAG of spans. Some embodiments may use the indirect links (that Open Telemetry offers) towards spans in the same trace or between traces, particularly when an observed task makes use of previously received data for processing a new data unit. This would then allow the span to have multiple incoming links and not being limited to a single parent. For example, a periodic task could have links to spans received during the last period, this would then allow analyzing across span graphs even though it is not a direct parent-child relation. Such analysis could be that previously received messages are handled in time. For example, the QoS requirements (e.g., regarding latency) could be evaluated against each linked span and the periodic task span as if they had a direct parent-child relation. Another example is that a quorum of linked spans and the periodic task span is evaluated to not violate the QoS requirements.

Observations and Measurements Derived from Observations

FIG. 1 shows fault mitigation in a distributed system, where each service instance is implemented with observability instrumentation, which collects observations on messages and status in the distributed system, including information about the service instance processing data units. Such collected observations may include trace, span, instance, and other identification to identify the task for which a corresponding data unit is processed.

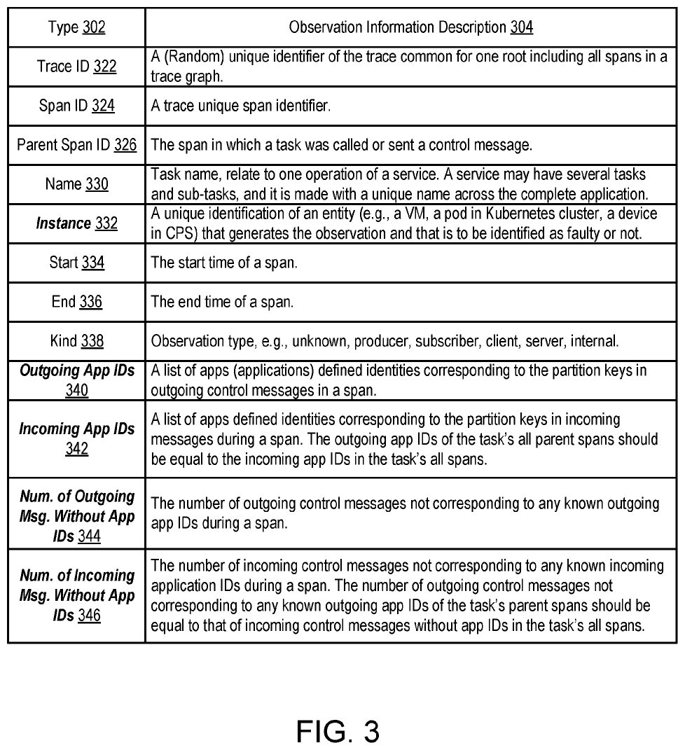

FIG. 3 illustrates a list of parameters that may be included in a collected observation from a service instance per some embodiments. The list of parameters is shown as a table, which includes multiple entries, and each entry includes a parameter type at reference 302 and a brief description of the parameter in the collected observation information at reference 304. The parameters include (1) ones that are defined in the Open Telemetry Specification and tailored to observation collection in a distributed system, and (2) ones that are implemented specifically for embodiments of the invention, the latter of which are shown with bold and italics font in the table. Not all values of the parameters need to be included in a given collected observation from a service instance, and a collected observation from a service instance may include values of other parameters in some embodiments. The values of these parameters are provided as observations/traces to a health monitoring module (e.g., health monitoring module 152) to derive measurements. For example, the values of Trace ID 322 and Span ID 324 are added as metadata to data units (included in the header or payload of the data units) to allow a health monitoring module (e.g., health monitoring module 152) to derive measurements.

The parameters defined in the Open Telemetry Specification are adapted to embodiments of the invention to identify the collected observation in a corresponding DAG of spans in some embodiments. Such parameters include (i) a trace ID at reference 322, which is a unique identifier (which can be predetermined or randomly generated) of the trace with one common root and including all spans following the root in a trace graph; (ii) a span ID at reference 324, which identifies the corresponding span uniquely in the trace; (iii) a parent span ID at reference 326, which identifies the span in which a corresponding task was called or sent a control message; (iv) a name at reference 330, which is the name of the task relate to operation of a service, and a service may have several tasks and sub-tasks, and the service is made with a unique name across the complete application; (v) start at reference 334, which indicates the start time of the corresponding span (e.g., the start time may be recorded using a timestamp identifying when a data unit starts to be processed in a span); (vi) end at reference 336, which indicates the end time of the corresponding span (e.g., the end time may be recorded using a timestamp identifying when a data unit finishes being processed in the span); and (vii) kind at reference 338, which indicates the observation type of the collected observation, e.g., it may be unknown, producer (a source service instance in a publication/subscription model), subscriber (a destination service instance in the publication/subscription model), client, server, and internal (for an internal task/local span).

The parameters implemented specifically for embodiments of the invention includes instance at reference 332, which is a unique identification of an entity (e.g., a VM, a pod in Kubernetes cluster, a device in CPS) that generates the observation, and that is to be identified as faulty or not.

The parameters may further include outgoing application (app) IDs (app ID and application ID are used interchangeably herein) at reference 340, which is a list of application defined identities corresponding to the partition keys in respective outgoing control messages during the span in some embodiments. A source service instance may produce an observation and send out multiple control messages, and potentially several destination service instances would receive messages with the same trace ID and parent span ID. Hence, just from these IDs, it may not be possible to track a data flow or know how many and which control messages should be received and handled. Yet the combination of a trace ID, a parent span ID, and an application ID may identify data units belonging to the same data flow. By adding the set of outgoing application IDs to the observations, it is possible to derive which application ID or IDs are expected to be received and handled at any of the destination service instances, which in turn produce observations including the handled incoming application IDs. The distribution of data flows with the corresponding application IDs could be made with a semi-static routing decision based on hashing as discussed herein above. For example, the route decision may be based on a hash of parts of the data unit, and the hash value for routing decision may be derived based on the application ID. This then causes any data unit from any of the source service instances containing a certain application ID to be routed to the same destination service instance (as long as the destination service instance is healthy), following the corresponding partition key as discussed herein above.

Additionally or alternatively, the parameters of a collected observation may include a list of incoming application IDs at reference 342, which identifies a list of application defined identities corresponding to the partition keys in incoming messages during the span. Note that the outgoing application IDs of a task's all parent spans should be equal to the incoming application IDs in the task's all spans. That is, if no control messages are lost, the outgoing application IDs from the all parent spans (corresponding outgoing application IDs) match the incoming application IDs to the tasks of the present span (corresponding incoming application IDs). From a mismatch and historic data of earlier observations with matching outgoing and incoming application IDs, a missing observation may be identified. The historic data may be stored in a log or another data structure (e.g., a table, a graphs of observations) in a database, which can be search and compared with current application IDs in some embodiments.

For example, a collected source service instance observation includes values of {Trace ID: aa, Span ID: 1, Start: 100, Outgoing App IDs: [a1,a2, a3]}, but within an allocate 15 time units (the monitoring duration may be determined by a QoS requirement), collected corresponding destination service instance observations include only (1) {Trace: aa, Span ID: 2, Parent Span ID: 1, Start: 110, Incoming App IDs: [a1]} and (2) {Trace: aa, Span ID: 3, Parent Span ID: 1, Start: 111, Incoming App IDs: [a2]}. A health monitoring module that has collected these observations may conclude that App ID a3 is not handled within the required 15 time units. From previous observations, it can be found that the mapping for a3 and this service/task is to a destination instance B #2, then the missing observation indicates that destination instance B #2 may be faulty. Note that a late observation (e.g., if the a3 observation is received after 15 time units) may be deemed as missing since the corresponding data unit is not processed within the given time period.

While application IDs may be assigned to observations and used to derive partition keys for routing, some data units may not have a known application ID assigned to them. A parameter of a collected observation may include the number of outgoing control messages not corresponding to any known outgoing application IDs during a span, as shown at reference 344. In the incoming direction, a parameter of a collected observation may include the number of incoming control messages not corresponding to any known incoming application IDs during a span, as shown at reference 346. Similar to the incoming and outgoing application ID lists, the number of outgoing control messages not corresponding to any known outgoing app IDs of the task's parent spans should be equal to that of incoming control messages without app IDs in the task's all spans.

The values of these parameters in collected observations from a service instance provide information about the service instance processing data units of one or more data flows when performing tasks, and they may be used to derive measurements about the performance of itself and/or its peer service instance (e.g., the corresponding source/destination service instance).

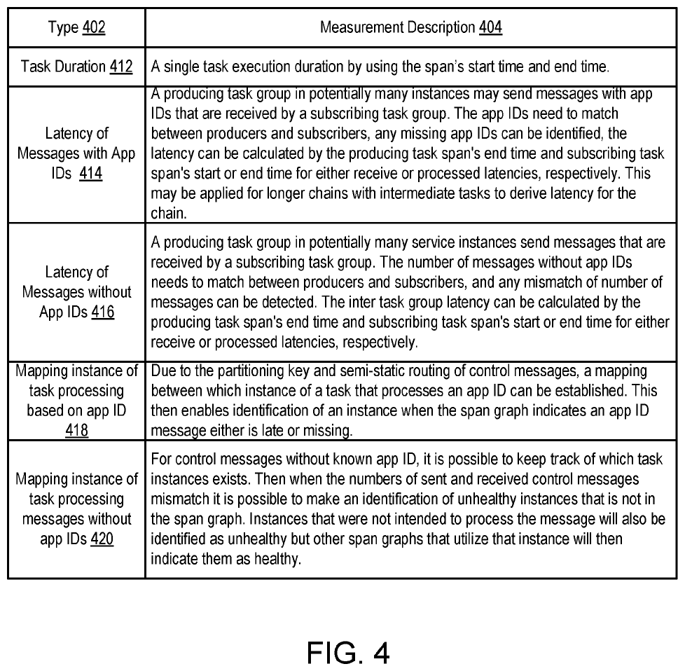

FIG. 4 illustrates a list of parameters that indicate performance of a source or destination service instance based on collected observations per some embodiments. The list of parameters is shown as a table, which includes multiple entries, and each entry includes a parameter type at reference 402 and a brief description of the parameter at reference 404. Not all the values of the parameters are included to determine the health of a particular service instance, and the health of a particular service instance may include values of other parameters in some embodiments. The values of the parameters may be derived by a health monitoring module (e.g., health monitoring module 152), a source/destination service instance (e.g., one of source/destination service instances 102 to 106 and 122 to 124).

The parameters may include a task duration at reference 412, which indicates the execution duration of a single task, and the execution duration may be determined based on the span's start time and end time (i.e., execution duration of a task=span's end time−span's start time).

The parameters may also include latency (or latencies) of messages with application ID at reference 414. A producing task group in potentially many instances may send control messages with application IDs that are received by a subscribing task group. The application IDs need to match between producers and subscribers. A mismatch can be used to identify any missing application IDs. Additionally, the corresponding latencies can be calculated: receive latency is calculated based on the producing task span's end time and subscribing task span's start time (receive latency=subscribing task span's start time−the producing task span's end time); and process latency based on the producing task span's end time and the end time subscribing task span's start time (process latency=subscribing task span's end time−the producing task span's end time). This could also be applied for longer chains with intermediate tasks to derive latency for the chain.

The parameters may further include latency (or latencies) of messages without application IDs at reference 416. A producing task group in potentially many service instances may send messages that are received by a subscribing task group. The number of control messages without app IDs needs to match between producers and subscribers, and any mismatch of number of control messages can be detected. Similar to the calculation of the latency (or latencies) of messages with application ID messages, the inter task group latency can be calculated by the producing task span's end time and subscribing task span's start or end time for either receive or processed latencies, respectively.

The parameters may additionally include mapping instance of task processing based on application ID at reference 418. Due to the partitioning key and semi-static routing of data flows, a mapping between which instance of a task that processes an application ID can be established. This then enables identification of an instance when the span graph indicates a control message with application ID is either late or missing.

Furthermore, the parameters may include mapping instance of task processing messages without app IDs at reference 420. For control messages without known application ID, it is possible to keep track of which task instances exists. Then when the numbers of sent and received control messages mismatch, it is possible to make an identification of unhealthy instances that is not in the span graph. Instances that were not intended to process the control message will also be identified as unhealthy but other span graphs that utilize that instance will then indicate them as healthy.

Values of these parameters are derived from information in the collected observations from source/destination service instances. These values, indicating latencies and/or missing control messages, identifies an unhealthy service instance, and that triggers circuit breaking, so that data flow distribution may be rerouted and the faulty service instance may be recycled.

A health monitoring module in a distributed system may continuously collect observations and derive measurements about the operations at the service instances. Since applications monitored are distributed in the system, the span observations arrive out of order and the span graph is built and verified continuously. And a faulty entity is identified by finding observations that violate QoS requirements for the application(s). Thus, in the distributed system, QoS requirements of an application is defined (e.g., one or more required limits on inter-task latency and task duration), and observations (e.g., including parameters/values explained about FIG. 3) are collected from source/destination service instances, measurements (e.g., including parameters/values explained about FIG. 4) are derived based on the observations. The measurements are compared against the QoS requirement to identify violation(s), which are used to identify the faulty service instance(s) (e.g., the latency over 20 millisecond points to service instance B #2 being faulty in FIG. 1). Once a faulty service instance is identified, data flows destined to the service instance is rerouted to a healthy service instance (the circuit breaking discussed herein above), and the faulty service instance is recycled by removing it and a new service instance with similar/identical functionalities are recreated.

The QoS requirements for an application include timing, reliability, and correctness for tasks and their relation to other tasks when processing the application. A task may have a requirement on the duration of the processing, and any span observation can then directly be compared with this duration requirement.

Additionally, the timing related QoS requirements may include ones between tasks are first based on a maximum latency allowed for any data units. When such maximum latency is reached, the operational correctness is analyzed (e.g., by the health monitoring module). All span observations of a specific task in each trace are collected, and the maximum latency added to the latest end time is used as the verification time. Then the operational correctness is checked, to do so, all application IDs sent out needs to have correspondingly been received and processed by the subscribers. Also, all parent-child span latencies are verified not to violate the maximum latency. Likewise, at such similar time (but towards another task) it is possible to verify that any message count corresponds between sending and receiving tasks' instances. Such timing related QoS requirements may be listed in the following format per task:

```
<task-name>:
  duration: <>
  children: <>
    <task-name>:
      latency_max: <>
      type: <app_id or count based>
```

When it is determined that an observation violates a corresponding QoS requirement, the correct violating service instance needs to be identified. The main difficulty is when the subscribing task's span observation is missing due to being late or potentially never arrives, the health monitoring can't just read the instance from the span that violated the requirements. Instead, that is derived from previously received spans in other span graphs, as the example about Trace aa above shows (where the control message with App ID a3 is determined to be missing). Such missing is then used to downgrade the reliability of that instance, which can be compensated for by receiving observations that the instance is healthy. When the health record of a service instance is downgraded to a certain level (e.g., latency of observed data flow to B #2 being above 20 milliseconds three out of seven times in a monitored period shown in FIG. 1), any data flows towards that instance are redirected and the service instance is recycled.

Measurements made and determinations are now described to provide a practical example as tested in one embodiment. For example, measurements may be made in a standard Kubernetes deployed on standard Openstack virtual machines (without real-time tuning). New data units are routed to a healthy existing pod (a service instance in Kubernetes) within about 307 milliseconds after being requested, at the time of the unhealthy decision. The detection of unhealthy pod takes around 239 milliseconds from start of extra latency being introduced. The variances for these measurements are around 10-15 milliseconds, for the eight tests that were conducted. It should be noted that the requirement is 100 millisecond latency and hence a violation of that can be detected first when 100 milliseconds has passed, also the exact time of the unhealthy decision is highly dependent on how the detection is tuned. Due to the large latency jitter in a standard cloud that execute applications in the (standard) CPython runtime, the detection needs to be tolerant to some jitter. In this case it was configured to require three faulty/missed observations within the last six observations from a pod. It can also be seen from the illustration that the faulty pod continues to serve data units, although potentially being late, until the re-routing is in place. The faulty pod is gracefully terminated (e.g., in 30 seconds) and a replacement pod is created ready to take over traffic at next fault.

While the timing related QoS requirements are explained in detail herein above, other QoS requirements be checked, including data unit jitter, data loss/degrade, out-of-order delivery, throughput, corrupted data, incomplete data, undecodable/unreadable data, and data processing exception, similar to what has been discussed herein above.

### Exemplary Implementation Per Some Embodiments

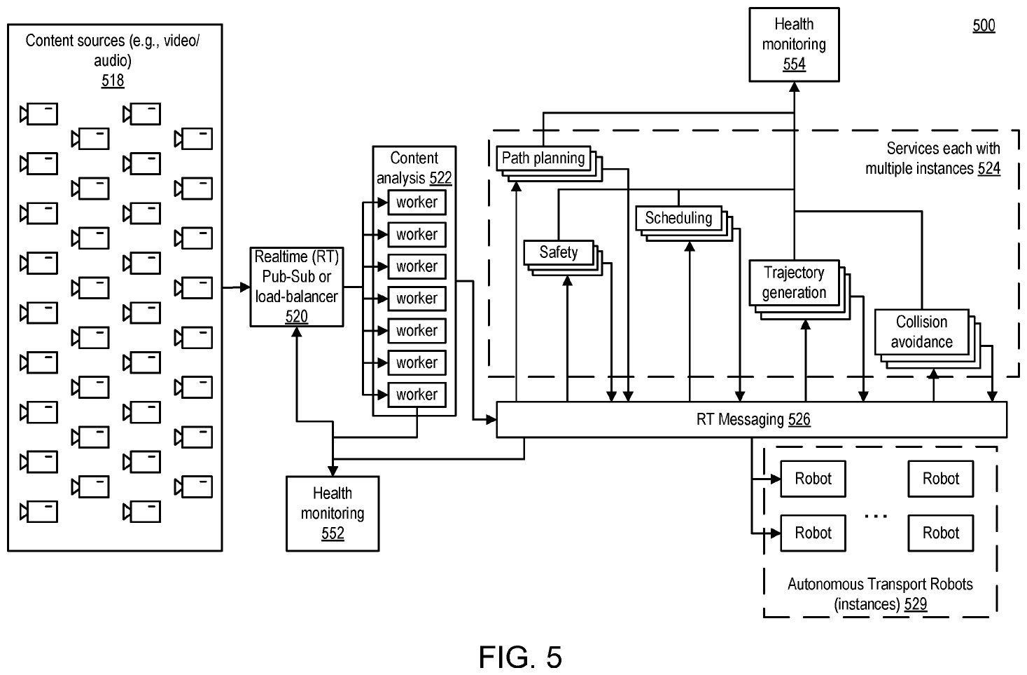

FIG. 5 illustrates an implementation of fault mitigation in a distributed system per some embodiments. The distributed system 500 is used to surveillance a location (e.g., a factory) and manage robots to operate at the location. The content sources 518 include video and audio content, and they include cameras and other sensors to monitor activities of the location. The content sources 518 are distributed by a real-time publication/subscription broker or load balancer module 520 to a content analysis module 55, which includes a number of workers, each can be viewed as a destination service instance. The module real-time publication/subscription broker or load balancer module 520 may include a distribution logic (e.g., distribution logic 134 described in FIG. 1).

Based on the analysis result by the content analysis module 522, a real-time messaging module 526 is to cause performance of numerous services, each service having multiple instances, as shown at reference 524. For example, the services include path planning (to plan the routes robots to travel), safety operations, scheduling (when/where the robots to move), trajectory generation, and collision avoidance (to prevent robots to collide with each other and other obstacles at the location). Additionally, the real-time messaging module 526 causes the robots, each being viewed as a service instance within the autonomous transport robots 529, to operate at the location. These multiple instances of services 524 and robot instances 529 may be reviewed as destination service instances while the real time messaging module may be a distribution logic (e.g., distribution logic 134 described in FIG. 1).

Note that a health monitoring module 552 may monitor the operations of the workers within the content analysis module 522 to identify a faulty worker. Similarly, a health monitoring module 554 may monitor the operations of the multiple instances of services 524 and robot instances 529 and identify faulty services and robots.

In one embodiment, the distributed system in FIG. 5 is implemented using a standard Kubernetes cluster deployment. The individual real-time components like real-time publication/subscription broker or load balancer module 520 and real-time messaging module 526 are deployed in pods, as are the workers in content analysis module 522.

### Operations Per Some Embodiments

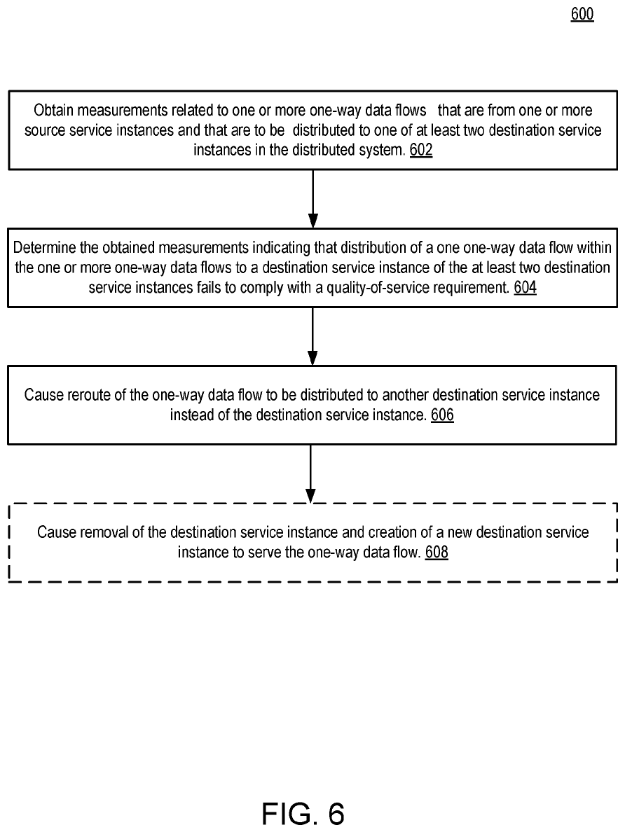

FIG. 6 is a flow diagram illustrating operations for fault mitigation per some embodiments. The operations of method 600 may be implemented in an electronic device implementing the health monitoring modules 152, 552, and/or 554.

At reference 602, the electronic device is to obtain measurements related to one or more one-way data flows that are from one or more source service instances and that are to be distributed to one of at least two destination service instances in a distributed system.

At reference 604, the electronic device is to determine the obtained measurements indicating that distribution of a one-way data flow within the one or more one-way data flows to a destination service instance of the at least two destination service instances fails to comply with a quality-of-service (QoS) requirement. In some embodiment, the determination of QoS requirement violation includes comparing obtained measurements to a threshold, as explained herein above relating to FIG. 1.

At reference 606, the electronic device is to cause reroute of the one-way data flow to be distributed to another destination service instance instead of the destination service instance.

Optionally at reference 608, the electronic device is to cause removal of the destination service instance and creation of a new destination service instance to serve the one-way data flow.

In some embodiments, the obtained measurements indicate latency of the distribution of the one-way data flow from the one or more source service instances to the destination service instance.

In some embodiments, the latency is derived based on start time and end time for processing a data unit within the one-way data flow in at least one of a source service instance and the destination service instance. The data unit may include a packet, a frame, or another protocol data unit (PDU) to carry a payload of a corresponding data flow; and additionally/alternatively, it may include metadata of the data flow and/or a control message, both of which may be included into a header or payload of the data unit. The duration between start time and end time for processing the data unit in a service instance indicates a task duration in the service instance.

In some embodiments, the latency is derived further based on end time for processing a data unit within the one-way data flow at a source service instance and start time for processing the data unit within the one-way data flow at the destination service instance. The duration between (1) the end time for processing the data unit at the source service instance and (2) start time for processing the data unit at the destination service instance indicates a receive latency for a data unit containing a control message with application ID, or an inter task group latency for a data unit containing a control message without application ID, both of which are discussed herein above relating to FIG. 4.

In some embodiments, the measurements indicate one or more data units missing within the one-way data flow from the one or more source service instances to the destination service instance. In some embodiments, the data unit missing is derived based on matching outgoing data units from the one or more source service instances with incoming data units to the at least two destination service instances. In some embodiments, the data unit missing is derived based on matching outgoing data units from the one or more source service instances with incoming data units to the at least two destination service instances. The determination of missing data units such as control messages are discussed herein above relating to FIGS. 3 and 4.

In some embodiments, the reroute of the one-way data flow to another destination service instance instead of the destination service instance comprises issuing a configuration message to change load-balancing to or subscription of the at least two destination service instances. The circuit breaking caused reroute is discussed herein above.

In some embodiments, each of the source and destination service instances is one of a virtual machine, a pod in a Kubernetes cluster, and a device in a cyber physical system as discussed herein above.

Through embodiments of the invention, faulty entities within a distributed system may be quickly identified and act upon based on the violation of QoS requirements, where collected observation information may be used to derive such violation. Such fault mitigation works well when data flows are distributed in a communication system that have multiple service instances for one or more services.

### Devices Implementing Embodiments of the Invention

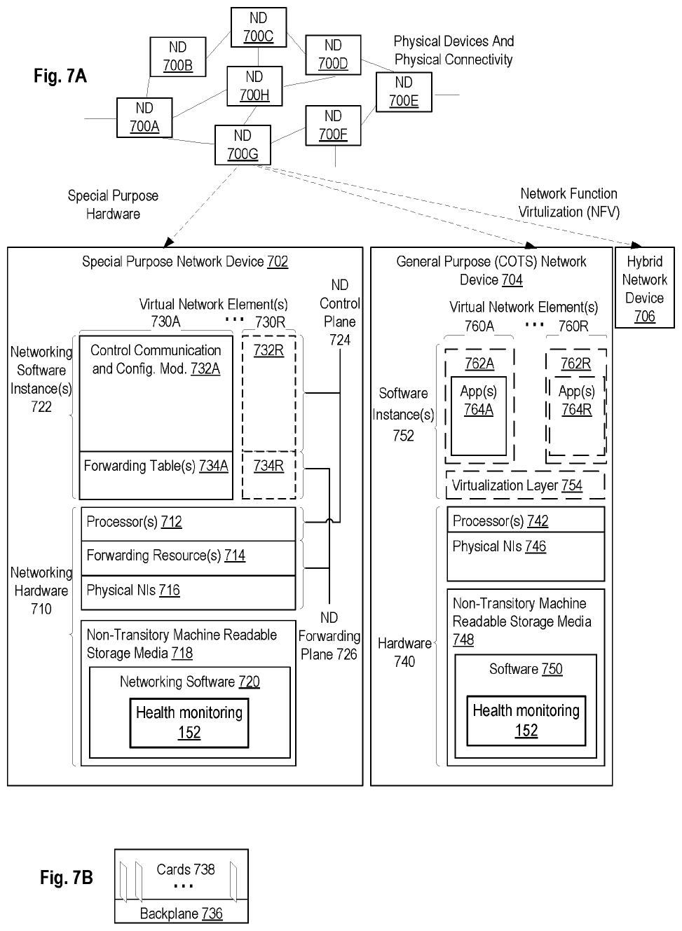

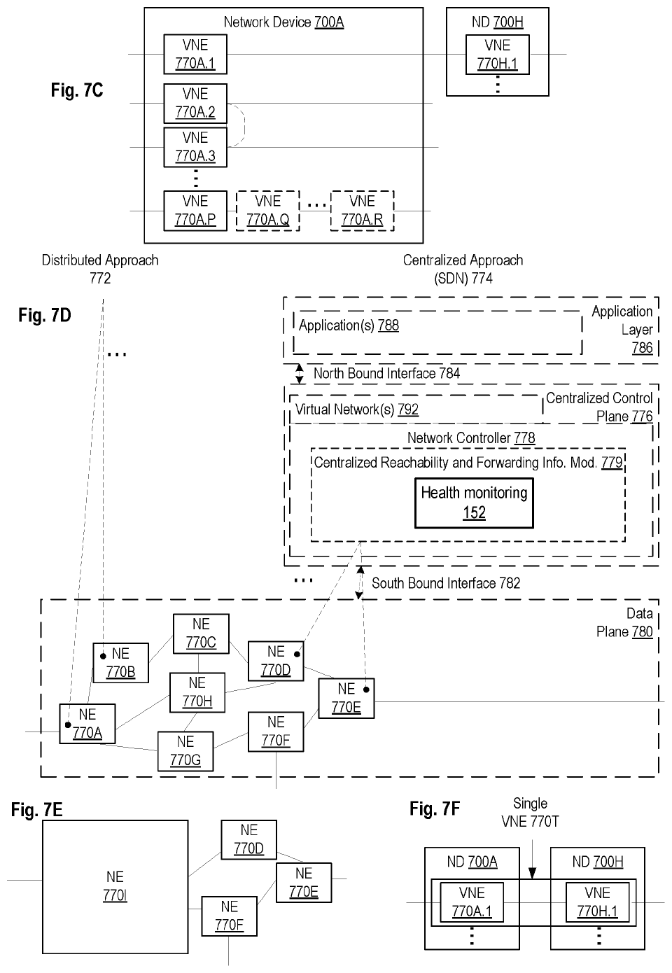

FIG. 7A illustrates connectivity between network devices (NDs) within an exemplary network, as well as three exemplary implementations of the NDs per some embodiments. FIG. 7A shows NDs 700A-H, and their connectivity by way of lines between 700A-700B, 700B-700C, 700C-700D, 700D-700E, 700E-700F, 700F-700G, and 700A-700G, as well as between 700H and each of 700A, 700C, 700D, and 700G. These NDs are physical devices, and the connectivity between these NDs can be wireless or wired (often referred to as a link). An additional line extending from NDs 700A, 700E, and 700F illustrates that these NDs act as ingress and egress points for the network (and thus, these NDs are sometimes referred to as edge NDs; while the other NDs may be called core NDs).

Two of the exemplary ND implementations in FIG. 7A are: 1) a special-purpose network device 702 that uses custom application-specific integrated-circuits (ASICs) and a special-purpose operating system (OS); and 2) a general-purpose network device 704 that uses common off-the-shelf (COTS) processors and a standard OS.

The special-purpose network device 702 includes networking hardware 710 comprising a set of one or more processor(s) 712, forwarding resource(s) 714 (which typically include one or more ASICs and/or network processors), and physical network interfaces (NIs) 716 (through which network connections are made, such as those shown by the connectivity between NDs 700A-H), as well as non-transitory machine readable storage media 718 having stored therein networking software 720. During operation, the networking software 720 may be executed by the networking hardware 710 to instantiate a set of one or more networking software instance(s) 722. Each of the networking software instance(s) 722, and that part of the networking hardware 710 that executes that network software instance (be it hardware dedicated to that networking software instance and/or time slices of hardware temporally shared by that networking software instance with others of the networking software instance(s) 722), form a separate virtual network element 730A-R. Each of the virtual network element(s) (VNEs) 730A-R includes a control communication and configuration module 732A-R (sometimes referred to as a local control module or control communication module) and forwarding table(s) 734A-R, such that a given virtual network element (e.g., 730A) includes the control communication and configuration module (e.g., 732A), a set of one or more forwarding table(s) (e.g., 734A), and that portion of the networking hardware 710 that executes the virtual network element (e.g., 730A). In some embodiments, the networking software 720 includes the health monitoring module 152 that that can be instantiated in the networking software instances 722, and that performs operations of fault mitigation as discussed herein above.

The special-purpose network device 702 is often physically and/or logically considered to include: 1) a ND control plane 724 (sometimes referred to as a control plane) comprising the processor(s) 712 that execute the control communication and configuration module(s) 732A-R; and 2) a ND forwarding plane 726 (sometimes referred to as a forwarding plane, a data plane, or a media plane) comprising the forwarding resource(s) 714 that utilize the forwarding table(s) 734A-R and the physical NIs 716. By way of example, where the ND is a router (or is implementing routing functionality), the ND control plane 724 (the processor(s) 712 executing the control communication and configuration module(s) 732A-R) is typically responsible for participating in controlling how data (e.g., packets) is to be routed (e.g., the next hop for the data and the outgoing physical NI for that data) and storing that routing information in the forwarding table(s) 734A-R, and the ND forwarding plane 726 is responsible for receiving that data on the physical NIs 716 and forwarding that data out the appropriate ones of the physical NIs 716 based on the forwarding table(s) 734A-R.

FIG. 7B illustrates an exemplary way to implement the special-purpose network device 702 per some embodiments. FIG. 7B shows a special-purpose network device including cards 738 (typically hot pluggable). While in some embodiments the cards 738 are of two types (one or more that operate as the ND forwarding plane 726 (sometimes called line cards), and one or more that operate to implement the ND control plane 724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 736 (e.g., a first full mesh coupling the line cards and a second full mesh coupling all of the cards).

Returning to FIG. 7A, the general-purpose network device 704 includes hardware 740 comprising a set of one or more processor(s) 742 (which are often COTS processors) and physical NIs 746, as well as non-transitory machine readable storage media 748 having stored therein software 750. During operation, the processor(s) 742 execute the software 750 to instantiate one or more sets of one or more applications 764A-R. While one embodiment does not implement virtualization, alternative embodiments may use different forms of virtualization. For example, in one such alternative embodiment the virtualization layer 754 represents the kernel of an operating system (or a shim executing on a base operating system) that allows for the creation of multiple instances 762A-R called software containers that may each be used to execute one (or more) of the sets of applications 764A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment, the virtualization layer 754 represents a hypervisor (sometimes referred to as a virtual machine monitor (VMM)) or a hypervisor executing on top of a host operating system, and each of the sets of applications 764A-R is run on top of a guest operating system within an instance 762A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels and sets of applications that are run in different software containers).

The instantiation of the one or more sets of one or more applications 764A-R, as well as virtualization if implemented, are collectively referred to as software instance(s) 752. Each set of applications 764A-R, corresponding virtualization construct (e.g., instance 762A-R) if implemented, and that part of the hardware 740 that executes them (be it hardware dedicated to that execution and/or time slices of hardware temporally shared), forms a separate virtual network element(s) 760A-R.

The virtual network element(s) 760A-R perform similar functionality to the virtual network element(s) 730A-R—e.g., similar to the control communication and configuration module(s) 732A and forwarding table(s) 734A (this virtualization of the hardware 740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 762A-R corresponding to one VNE 760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 762A-R to VNEs also apply to embodiments where such a finer level of granularity and/or unikernels are used.

In certain embodiments, the virtualization layer 754 includes a virtual switch that provides similar forwarding services as a physical Ethernet switch. Specifically, this virtual switch forwards traffic between instances 762A-R and the physical NI(s) 746, as well as optionally between the instances 762A-R; in addition, this virtual switch may enforce network isolation between the VNEs 760A-R that by policy are not permitted to communicate with each other (e.g., by honoring virtual local area networks (VLANs)). In some embodiments, the networking software 750 includes the health monitoring module 152 that that can be instantiated in the software instances 752, and that performs operations of fault mitigation as discussed herein above. The health monitoring module 152 includes computer program comprising instructions, which when the computer program is executed by the network device that store such computer program, is capable of causing the electronic device to perform the operations of fault mitigation in some embodiments.

The third exemplary ND implementation in FIG. 7A is a hybrid network device 706, which includes both custom ASICs/special-purpose OS and COTS processors/standard OS in a single ND or a single card within an ND. In certain embodiments of such a hybrid network device, a platform VM (i.e., a VM that implements the functionality of the special-purpose network device 702) could provide for para-virtualization to the networking hardware present in the hybrid network device 706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also, in all of the above exemplary implementations, each of the VNEs (e.g., VNE(s) 730A-R, VNEs 760A-R, and those in the hybrid network device 706) receives data on the physical NIs (e.g., 716, 746) and forwards that data out of the appropriate ones of the physical NIs (e.g., 716, 746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 7C illustrates various exemplary ways in which VNEs may be coupled per some embodiments. FIG. 7C shows VNEs 770A.1-770A.P (and optionally VNEs 770A.Q-770A.R) implemented in ND 700A and VNE 770H.1 in ND 700H. In FIG. 7C, VNEs 770A.1-P are separate from each other in the sense that they can receive packets from outside ND 700A and forward packets outside of ND 700A; VNE 770A.1 is coupled with VNE 770H.1, and thus they communicate packets between their respective NDs; VNE 770A.2-770A.3 may optionally forward packets between themselves without forwarding them outside of the ND 700A; and VNE 770A.P may optionally be the first in a chain of VNEs that includes VNE 770A.Q followed by VNE 770A.R (this is sometimes referred to as dynamic service chaining, where each of the VNEs in the series of VNEs provides a different service—e.g., one or more layer 4-7 network services). While FIG. 7C illustrates various exemplary relationships between the VNEs, alternative embodiments may support other relationships (e.g., more/fewer VNEs, more/fewer dynamic service chains, multiple different dynamic service chains with some common VNEs and some different VNEs).

A virtual network is a logical abstraction of a physical network (such as that in FIG. 7A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 7D illustrates a network with a single network element on each of the NDs of FIG. 7A, and within this straight forward approach contrasts a traditional distributed approach (commonly used by traditional routers) with a centralized approach for maintaining reachability and forwarding information (also called network control) per some embodiments. Specifically, FIG. 7D illustrates network elements (NEs) 770A-H with the same connectivity as the NDs 700A-H of FIG. 7A.

FIG. 7D illustrates that the distributed approach 772 distributes responsibility for generating the reachability and forwarding information across the NEs 770A-H; in other words, the process of neighbor discovery and topology discovery is distributed.

For example, where the special-purpose network device 702 is used, the control communication and configuration module(s) 732A-R of the ND control plane 724 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 770A-H (e.g., the processor(s) 712 executing the control communication and configuration module(s) 732A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 724. The ND control plane 724 programs the ND forwarding plane 726 with information (e.g., adjacency and route information) based on the routing structure(s). For example, the ND control plane 724 programs the adjacency and route information into one or more forwarding table(s) 734A-R (e.g., Forwarding Information Base (FIB), Label Forwarding Information Base (LFIB), and one or more adjacency structures) on the ND forwarding plane 726. For layer 2 forwarding, the ND can store one or more bridging tables that are used to forward data based on the layer 2 information in that data. While the above example uses the special-purpose network device 702, the same distributed approach 772 can be implemented on the general-purpose network device 704 and the hybrid network device 706.

FIG. 7D illustrates that a centralized approach 774 (e.g., software defined networking (SDN)) that decouples the system that makes decisions about where traffic is sent from the underlying systems that forwards traffic to the selected destination. The illustrated centralized approach 774 has the responsibility for the generation of reachability and forwarding information in a centralized control plane 776 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 776 has a south bound interface 782 with a data plane 780 (sometime referred to the infrastructure layer, network forwarding plane, or forwarding plane (which should not be confused with a ND forwarding plane)) that includes the NEs 770A-H (sometimes referred to as switches, forwarding elements, data plane elements, or nodes). The centralized control plane 776 includes a network controller 778, which includes a centralized reachability and forwarding information module 779 that determines the reachability within the network and distributes the forwarding information to the NEs 770A-H of the data plane 780 over the south bound interface 782 (which may use the OpenFlow protocol). Thus, the network intelligence is centralized in the centralized control plane 776 executing on electronic devices that are typically separate from the NDs.

For example, where the special-purpose network device 702 is used in the data plane 780, each of the control communication and configuration module(s) 732A-R of the ND control plane 724 typically include a control agent that provides the VNE side of the south bound interface 782. In this case, the ND control plane 724 (the processor(s) 712 executing the control communication and configuration module(s) 732A-R) performs its responsibility for participating in controlling how data (e.g., packets) is to be routed (e.g., the next hop for the data and the outgoing physical NI for that data) through the control agent communicating with the centralized control plane 776 to receive the forwarding information (and in some cases, the reachability information) from the centralized reachability and forwarding information module 779 (it should be understood that in some embodiments of the invention, the control communication and configuration module(s) 732A-R, in addition to communicating with the centralized control plane 776, may also play some role in determining reachability and/or calculating forwarding information-albeit less so than in the case of a distributed approach; such embodiments are generally considered to fall under the centralized approach 774, but may also be considered a hybrid approach).

While the above example uses the special-purpose network device 702, the same centralized approach 774 can be implemented with the general purpose network device 704 (e.g., each of the VNE 760A-R performs its responsibility for controlling how data (e.g., packets) is to be routed (e.g., the next hop for the data and the outgoing physical NI for that data) by communicating with the centralized control plane 776 to receive the forwarding information (and in some cases, the reachability information) from the centralized reachability and forwarding information module 779; it should be understood that in some embodiments of the invention, the VNEs 760A-R, in addition to communicating with the centralized control plane 776, may also play some role in determining reachability and/or calculating forwarding information-albeit less so than in the case of a distributed approach) and the hybrid network device 706. In fact, the use of SDN techniques can enhance the NFV techniques typically used in the general-purpose network device 704 or hybrid network device 706 implementations as NFV is able to support SDN by providing an infrastructure upon which the SDN software can be run, and NFV and SDN both aim to make use of commodity server hardware and physical switches. Note that the health monitoring module 152 may be included in network controller 778, e.g., as a module in the centralized reachability and forwarding information module 779. That allows an electronic device implementing the centralized control plane 776 to perform fault mitigation discussed herein above for the data flow in the data plane 780.

FIG. 7D also shows that the centralized control plane 776 has a north bound interface 784 to an application layer 786, in which resides application(s) 788. The centralized control plane 776 has the ability to form virtual networks 792 (sometimes referred to as a logical forwarding plane, network services, or overlay networks (with the NEs 770A-H of the data plane 780 being the underlay network)) for the application(s) 788. Thus, the centralized control plane 776 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 7D shows the distributed approach 772 separate from the centralized approach 774, the effort of network control may be distributed differently or the two combined in certain embodiments of the invention. For example: 1) embodiments may generally use the centralized approach (SDN) 774, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 774 but may also be considered a hybrid approach.

While FIG. 7D illustrates the simple case where each of the NDs 700A-H implements a single NE 770A-H, it should be understood that the network control approaches described with reference to FIG. 7D also work for networks where one or more of the NDs 700A-H implement multiple VNEs (e.g., VNEs 730A-R, VNEs 760A-R, those in the hybrid network device 706). Alternatively or in addition, the network controller 778 may also emulate the implementation of multiple VNEs in a single ND. Specifically, instead of (or in addition to) implementing multiple VNEs in a single ND, the network controller 778 may present the implementation of a VNE/NE in a single ND as multiple VNEs in the virtual networks 792 (all in the same one of the virtual network(s) 792, each in different ones of the virtual network(s) 792, or some combination). For example, the network controller 778 may cause an ND to implement a single VNE (a NE) in the underlay network, and then logically divide up the resources of that NE within the centralized control plane 776 to present different VNEs in the virtual network(s) 792 (where these different VNEs in the overlay networks are sharing the resources of the single VNE/NE implementation on the ND in the underlay network).

On the other hand, FIGS. 7E and 7F, respectively, illustrate exemplary abstractions of NEs and VNEs that the network controller 778 may present as part of different ones of the virtual networks 792. FIG. 7E illustrates the simple case of where each of the NDs 700A-H implements a single NE 770A-H (see FIG. 7D), but the centralized control plane 776 has abstracted multiple of the NEs in different NDs (the NEs 770A-C and G-H) into (to represent) a single NE 770I in one of the virtual network(s) 792 of FIG. 7D per some embodiments. FIG. 7E shows that in this virtual network, the NE 770I is coupled to NE 770D and 770F, which are both still coupled to NE 770E.

FIG. 7F illustrates a case where multiple VNEs (VNE 770A.1 and VNE 770H.1) are implemented on different NDs (ND 700A and ND 700H) and are coupled to each other, and where the centralized control plane 776 has abstracted these multiple VNEs such that they appear as a single VNE 770T within one of the virtual networks 792 of FIG. 7D per some embodiments. Thus, the abstraction of a NE or VNE can span multiple NDs.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address).

Some of the embodiments contemplated herein above are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

### Terms

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, refers to any positive whole number of items including one item.

An electronic device stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals-such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

A network device (ND) (also referred as a network node or simply node) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

The terms “module,” “logic,” and “unit” used in the present application, may refer to a circuit for performing the function specified. In some embodiments, the function specified may be performed by a circuit in combination with software such as by software executed by a general purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to mitigate fault in a distributed system, the method comprising:
obtaining measurements related to one or more one-way data flows that are from one or more source service instances and that are to be distributed to one of at least two destination service instances in the distributed system;
determining the measurements indicating that distribution of a one-way data flow within the one or more one-way data flows to a destination service instance of the at least two destination service instances fails to comply with a quality-of-service requirement; and
causing reroute of the one-way data flow to be distributed to another destination service instance instead of the destination service instance.

2. The method of claim 1, wherein the measurements indicate latency of the distribution of the one-way data flow from the one or more source service instances to the destination service instance.

3. The method of claim 1, wherein the latency is derived based on start time and end time for processing a data unit within the one-way data flow in at least one of a source service instance and the destination service instance.

4. The method of claim 3, wherein the latency is derived further based on end time for processing a data unit within the one-way data flow at a source service instance and start time for processing the data unit within the one-way data flow at the destination service instance.

5. The method of claim 1, wherein the measurements indicate one or more data units missing within the one-way data flow from the one or more source service instances to the destination service instance.

6. The method of claim 5, wherein the data unit missing of the one or more data units is derived based on matching outgoing data units from the one or more source service instances with incoming data units to the at least two destination service instances.

7. The method of claim 6, wherein matching the outgoing data units from the one or more source service instances with incoming data units to the at least two destination service instances comprises comparing application identifiers of the outgoing and incoming data units.

8. The method of claim 1, wherein the reroute of the one-way data flow to another destination service instance instead of the destination service instance comprises issuing a configuration message to change load-balancing to or subscription of the at least two destination service instances.

9. The method of claim 1, further comprising:
causing removal of the destination service instance and creation of a new destination service instance to serve the one-way data flow.

10. The method of claim 1, wherein each of the source and destination service instances is one of a virtual machine, a pod in a Kubernetes cluster, and a device in a cyber physical system.

11. An electronic device to mitigate fault in a distributed system, comprising:
a processor and non-transitory machine-readable storage medium that provides instructions that, when executed by the processor are capable of causing the processor to perform:
obtaining measurements related to one or more one-way data flows that are from one or more source service instances and that are to be distributed to one of at least two destination service instances in the distributed system;
determining the measurements indicating that distribution of a one-way data flow within the one or more one-way data flows to a destination service instance of the at least two destination service instances fails to comply with a quality-of-service requirement; and
causing reroute of the one-way data flow to be distributed to another destination service instance instead of the destination service instance.

12. The electronic device of claim 11, wherein the measurements indicate latency of the distribution of the one-way data flow from the one or more source service instances to the destination service instance.

13. (canceled)

14. (canceled)

15. The electronic device of claim 11, wherein the measurements indicate one or more data units missing within the one-way data flow from the one or more source service instances to the destination service instance.

16. The electronic device of claim 15, wherein data unit missing of the one or more data units is derived based on matching outgoing data units from the one or more source service instances with incoming data units to the at least two destination service instances.

17. The electronic device of claim 16, wherein the data unit missing is derived based on matching outgoing data units from the one or more source service instances with incoming data units to the at least two destination service instances.

18. (canceled)

19. (canceled)

20. (canceled)

21. A non-transitory machine-readable storage medium that provides instructions that, when executed by a processor, are capable of causing the processor to perform:
obtaining measurements related to one or more one-way data flows that are from one or more source service instances and that are to be distributed to one of at least two destination service instances in a distributed system;
determining the measurements indicating that distribution of a one-way data flow within the one or more one-way data flows to a destination service instance of the at least two destination service instances fails to comply with a quality-of-service requirement; and
causing reroute of the one-way data flow to be distributed to another destination service instance instead of the destination service instance.

22. The non-transitory machine-readable storage medium of claim 21, wherein the measurements indicate latency of the distribution of the one-way data flow from the one or more source service instances to the destination service instance.

23. (canceled)

24. (canceled)

25. (canceled)

26. (canceled)

27. (canceled)

28. The non-transitory machine-readable storage medium of claim 21, the reroute of the one-way data flow to another destination service instance instead of the destination service instance comprises issuing a configuration message to change load-balancing to or subscription of the at least two destination service instances.

29. The non-transitory machine-readable storage medium of claim 21, wherein the instructions when executed by the processor, are capable of causing the processor to further perform:
causing removal of the destination service instance and recreation of a new destination service instance to serve the one-way data flow.

30. The non-transitory machine-readable storage medium of claim 21, wherein each of the source and destination service instances is one of a virtual machine, a pod in a Kubernetes cluster, and a device in a cyber physical system.

31. (canceled)
